(19) United States
(12) Patent Application Publication
(10) Pub. No.: US 2006/0193762 A1
(43) Pub. Date: Aug. 31, 2006

(54) Catalyzed dissolution of copper from sulfur-containing copper minerals

(76) Inventors: Manoranjan Misra, Reno, NV (US); Maurice C Fuerstenau, Reno, NV (US)

Correspondence Address: GREENLEE WINNER AND SULLIVAN P C, 4875 PEARL EAST CIRCLE, SUITE 200, BOULDER, CO, 80301, US

(21) Appl. No.: 10/528,532

(22) PCT Filed: Sep. 26, 2003
(86) PCT No.: PCT/US03/30276

§ 371 Date: Mar. 23, 2006

Related U.S. Application Data
(60) Provisional application No. 60/414,608, filed on Sep. 27, 2002.

(51) Int. Cl. C01G 5/00

(52) U.S. Cl. 423/42

(57) ABSTRACT

Leaching of copper from minerals containing sulfur and copper is hampered by the formation of sulfur on the surface of the mineral during conventional processing. An improved method for extracting copper from a sulfur-containing copper mineral is provided, comprising adding a lixiviant and a silica-containing or titanium-containing compound to a sulfur-containing copper mineral.

### CROSS-REFERENCE TO RELATED APPLICATIONS

This application claims the benefit of U.S. Provisional Application No. 60/414,608, filed Sep. 27, 2002, which is incorporated by reference to the extent not inconsistent with the disclosure herewith.

### BACKGROUND OF THE INVENTION

The present invention relates generally to a cost-effective process for enhanced dissolution of copper from chalcopyrite or other sulfur-containing copper minerals in an acidic oxidative leaching system in the presence of silica-containing or titanium-containing compounds.

Chalcopyrite is the most abundant and important source of copper metal available in the earth's crust [Fathi, 1978]. It contains nearly equal parts of copper, iron, and sulfur. The chemical formula is generally written as CuFeS₂, since copper is mainly in a cuprous state and iron in a ferric state. It is found with many sulfide minerals of magnetic origin. It is seen in the metalliferrous veins of igneous rocks and in sediments. It may also occur in the secondary enrichment zones of many mineral deposits.

A single crystal of chalcopyrite behaves like a typical semiconductor with a conductivity of 8 to 20 ohm⁻¹ cm⁻¹. It is antiferromagnetic with a hardness of 3.5 to 4.0 on the Mohr scale. The specific gravity is around 4.2. It is closely related to bornite, Cu₅FeS₄, idaite, Cu₅FeS₆, and cubanite, CuFe₂S₃.

The crystal structure of chalcopyrite is tetragonal and it is approximately twice the size of sphalerite. Each metal atom (copper and iron) is coordinated by a tetrahedron of sulfur atoms, and the sulfur atom by a tetrahedron of two copper and two iron atoms. However, the sulfur atom is displaced slightly from the center of the metal tetrahedron, towards the iron-iron edge. The interatomic distance of copper-sulfur is 230.2 pico metre (pm) and iron-sulfur is 225.7 pm. The bonding is essentially covalent in nature with the atoms fluctuating between two ionic states Cu⁺Fe³⁺S²⁻₂ and Cu²⁺Fe³⁺S²⁻₂. It is also suggested by Wyckoff [1970] that the resistance of chalcopyrite to bacterial attack Is mainly because of these two ionic states. The first species is more resistant than the second one to bacterial attack.

In the usual extraction procedure, the valuable component, copper, is extracted from chalcopyrite by leaching using suitable lixiviants. Widely used lixiviants for chalcopyrite are ferric chloride and ferric sulfate in an acidic medium. The ferric chloride leaching reaction can be written as [Dutrizac, 1978]:
3.5FeCl₃+CuFeS₂→0.5CuCl₂+0.5CuCl+4.5FeCl₂+2S⁰ (1)

In sulfuric acid containing solutions with ferric sulfate the reaction follows [Mateos et al., 1987]:
CuFeS₂+4Fe³⁺→Cu²⁺5Fe²⁺+2S₀ (2)

In ammoniacal solution, the reaction is seen to produce thiosulfate and elemental sulfur as below [Reilly and Scott, 1984]:
CuFeS₂+4NH₃+6OH→Cu(NH₃)₄⁺²+½S₂O₃⁻²+S⁰+Fe(OH)₃+ 3/2H₂+7e (3)

The sulfur layer that forms on the surface of the chalcopyrite in all of the above reactions is passivating and highly protective. Hackl et al. [1995] suggests that this layer is made of copper polysulfide, CuSₙ. XPS analysis conducted by Balaz et al. [1996] revealed the existence of sulfur in three different chemical forms: S⁻², S⁰, and S⁶⁺, when experiments were performed under a combined bacterial and chemical leaching. Other investigators such as Antonijevic et al. [1994] suggest the sulfur to be elemental in nature. Biegler and Swift [1979] observed the properties of sulfur to vary with experimental conditions. When standing over a period of days, sulfur lightened in color due to transformation to the yellow rhombic form. However, there is no consensus as to the nature of the sulfur associated with the passive layer that is formed during chalcopyrite leaching. Nevertheless, it has been established that the decreased leaching of chalcopyrite is due to the passive sulfur layer formation.

Munoz, Miller, and Wadsworth [1979] achieved a maximum copper recovery of about 58% in 20 hours with 4-micron particle size chalcopyrite under drastic conditions of 90° C., 1200 rpm with 1.0 M sulfuric acid. When the particle size was increased to 12 microns, in order to achieve almost the same recovery, leaching had to be performed for 100 hours. When 47-micron particle size was used, it was not possible to achieve more than 20% even after 160 hours. To increase recovery, investigators have tried a number of methods. One of the most successful was developed by Miller et al. [1979] using silver catalysis. In this method, recovery was increased to almost 100%. However, the economics of using silver to extract copper restrict its widespread use. Ozone oxidation was also tried by Halvik and Skrobian [1990]. The proposed reaction is below:
3CuFeS₂+8O₃→3CuSO₄+3FeSO₄ (4)
Again, this process had poor economics and was difficult to commercialize.

The use of high oxidation potential offers another possibility to dissolve chalcopyrite. Chalcopyrite can be made the anode in an aqueous electrolyte with a counter electrode to complete the circuit. The anodic dissolution reaction [Illangovan et al., 1975] can be written as:
CuFeS₂→Cu²⁺+Fe²⁺+2S+4e⁻(anodic) (5)
And the corresponding cathodic reaction is:
Cu²⁺+2e⁻→Cu (cathodic) (6)

Kruesi et al. [1974] combined chemical leaching with anodic leaching as:
CuFeS₂+3FeCl₃→CuCl+4FeCl₂+2S (leaching) (7)
CuFeS₂+3HCl →CuCl+FeCl₂+3H⁺+2S+3e⁻(anodic) (8)
CuCl+e⁻→Cu+Cl⁻(cathodic) (9)
H⁺+Cl⁻→HCl (cathodic) (10)
Ferrous chloride solution was electrolyzed separately to get metallic iron. Thus the solution can be regenerated as follows:
FeCl₂+2e⁻→Fe+2Cl⁻(cathodic) (11)
FeCl₂+Cl⁻→FeCl₃+e⁻(anodic) (12)

Ilangovan et al. [1975] used a diaphragm made of chlorinated polyvinyl chloride as the anode compartment and a mixture of sulfuric acid and ferric chloride as electrolyte. The reactions found to take place were:
CuFeS₂→Cu²⁺+Fe³⁺+2S+5e⁻(anodic) (13)
Cu²⁺+2e →Cu (cathodic) (14)
Fe³⁺+e⁻→Fe²⁺(cathodic) (15)
2H⁺+2e⁻→H₂ (cathodic) (16)

There have been various other studies conducted to dissolve chalcopyrite using an anodic potential, however, the sulfur containing passive layer acts as an insulator between sulfide particles and increases the cell voltage tremendously with the reaction. This is a major problem and with the low conductivity of ores, makes the electrochemical method impractical. The passive layer problem exists in chemical leaching processing also.

The following electrolytic reactions are observed in hydrochloric medium [Biegler et al., 1976]:
2CuFeS₂+6H⁺+2e⁻→Cu₂S+2Fe²⁺+3H₂S (cathodic) (17)
2H⁺+2e⁻→H₂ (cathodic) (18)
2Cl⁻→Cl₂+2e (anodic) (19)
From the above equations it can be seen that the products formed are not insulators like sulfur in the anodic process. Therefore, increased cell potential is not a problem. However, the conductivity of the mineral plays a crucial role in the feasibility of this approach.

There is a need in the art for an improved method for leaching of copper from minerals containing copper and sulfur.

### BRIEF SUMMARY OF THE INVENTION

The present invention is a method for extraction of copper from copper-containing minerals using silica-containing compounds or titanium-containing compounds and one or more lixiviants. Silica-containing compounds that are useful in the invention include SiO₂, silicic acid, fluorosilicic acid, glass sand, borosilicate, dissolved silica, silica gel, colloidal silica and mixtures thereof. Titanium-containing compounds that are useful in the invention include titanium dioxide (TiO₂), preferably nanosize titanium dioxide. The silica-containing or titanium-containing compounds may be in any suitable form and any suitable size, for example finely divided or nanosize.

More particularly, provided is a method of extracting copper from a copper-containing mineral comprising: adding a lixiviant and a silica-containing compound or titanium-containing compound to a copper-containing mineral, forming a composition, and separating the copper extracted from the composition. The lixiviant and silica-containing compound or titanium-containing compound may be added to the mineral in any order. The mineral is treated for a sufficient time to extract the desired amount of copper. The composition may be agitated or otherwise treated, as known in the art. The methods of the invention may further comprise adjusting the pH of the composition to be acidic, adjusting the temperature of the composition to between about 25 and about 85° C., applying light (preferably ultraviolet) to the composition, or any combination. When light is applied, a suitable amount of light at a suitable wavelength or wavelengths is applied for a suitable time, to extract the desired amount of copper, as easily determined by one of ordinary skill in the art without undue experimentation. Preferred examples of suitable wavelengths of light include one or more wavelengths in the visible spectrum or one or more wavelengths in the ultraviolet spectrum. All intermediate values and ranges of parameters given are included in this disclosure. Preferred temperature ranges include above 45° C., between 45 and 75° C., and between 50 and 75° C.

As used herein “lixiviant” is a chemical which leaches copper from a copper-containing mineral. Suitable lixiviants include ferric ion, hydrogen peroxide, chlorate, permanganate, bleach, ethylene glycol, oxidants, iodide and bacteria or a combination thereof. Other standard lixiviants used in the art are also useful in the methods of the invention. The concentration of lixiviants used may be any concentration to give the desired amount of extraction, as described herein.

“Composition” does not mean a homogeneous solution is formed, merely that the mineral and chemicals are in sufficient contact with each other so that the desired reaction takes place. The composition may further contain components other than those specifically exemplified herein.

Although chalcopyrite is the preferred copper-containing mineral for use in the invention, the invention is not limited for use with chalcopyrite. Any copper-containing mineral may be used. This invention is not limited in use to any particular form or size of copper-containing mineral. The copper-containing mineral may be in any suitable form or size, including as found without further processing, crushed or milled. One presently preferred mineral size is smaller than 50 mesh (about 200 microns). The preferred copper-containing mineral includes sulfur. Minerals that comprise copper and sulfur may be treated using the methods of the invention. These minerals include chalcopyrite, bornite, chalcosite and others known in the art. The concentration of copper-containing mineral in the compositions described herein is not limited, but is any concentration that allows the desired level of copper extraction. It is presently preferred that the concentration of copper-containing mineral: (silica-containing compound or titanium-containing compound) be around 1:1, however, other concentrations such as 0.3:1, 1:0.3, 0.5:1, 1:0.5, 0.75:1, 1:0.75, 1.5:1, and 1:1.5 and all intermediate values therein may be used without undue experimentation by one of ordinary skill in the art, as shown herein.

### BRIEF DESCRIPTION OF THE FIGURES

FIG. 1A is a SEM photograph of chalcopyrite surface at pH 1.3 with H₂SO₄ showing the presence of a sulfur layer.

FIG. 1B is a SEM photograph of chalcopyrite surface when exposed to nanosize silica in the presence of 0.5 N H₂SO₄ and peroxide, showing the presence of silica and no sulfur.

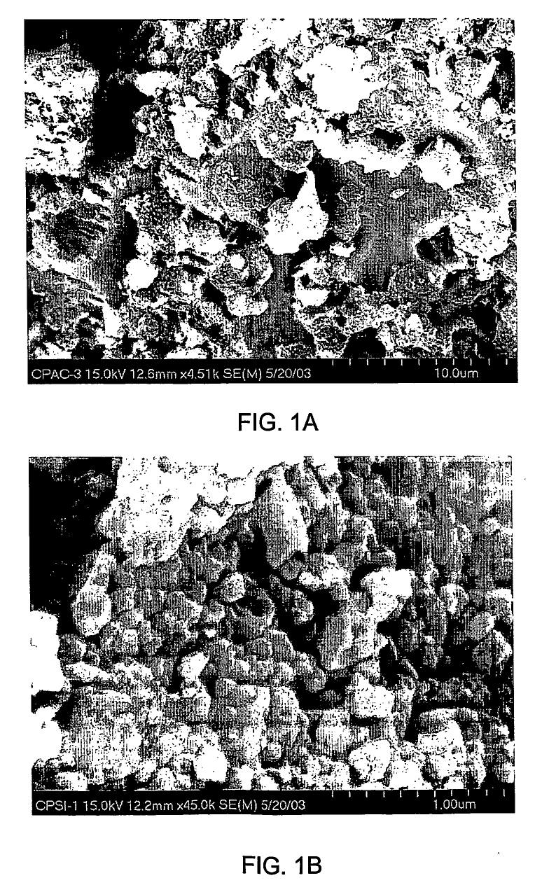

### DETAILED DESCRIPTION OF THE INVENTION

The invention may be further understood by reference to the following non-limiting examples. In general, chalcopyrite was mixed with lixiviant and other additives and conditioned for specific time. After a specific conditioning time, the soluble copper was removed from the slurry by filtration. After filtration, the filtrate was analyzed for copper using Atomic Absorption Spectroscopic technique.

### EXAMPLE I

As discussed, the formation of a passive sulfur layer decreases the dissolution of copper from chalcopyrite significantly when leaching is conducted in acidic pH. In order to test that and to get baseline data, chalcopyrite leaching experiments were conducted using ferric as a lixiviant in the absence and presence of different salts. Experimental results are given in Table 1.

TABLE 1
Leaching of Chalcopyrite with Ferric Lixiviants
(200 mesh size, Temp. 50° C.)

| | % Copper | % Copper |
|---|---|---|
| | Recovery | Recovery |
| | after 15 hrs. | after 72 hrs. |
| Conditions | Leaching | Leaching |
| 6 gm/liter chalcopyrite | 8.4 | 14.5 |
| 10 gm/liter ferric-chloride | | |
| 1.3 pH using H₂SO₄ | | |
| 6 gm/liter chalcopyrite | 10.7 | 19.1 |
| 10 gm/liter ferric-chloride | | |
| 8 gm/liter Thiourea | | |
| 1.3 pH using H₂SO₄ | | |
| 6 gm/liter chalcopyrite | 12.6 | 14 |
| 10 gm/liter ferric-chloride | | |
| 8 gm/liter Thiosulfate | | |
| 1.3 pH using H₂SO₄ | | |

Ferric chloride leaching for 72 hours showed 14% copper dissolution. Addition of thiosulfate and thiourea did not enhance copper recovery.

### EXAMPLE II

### Effect of Selected Oxidants

Experiments were conducted in a manner similar to that described in Example I. In this case some strong oxidants were used to destroy the sulfur which would increase the dissolution of copper from chalcopyrite.

TABLE 2
Effect of Selected Oxidants on the Leaching of
Chalcopyrite (200 mesh size, Temp. 50° C.)

| | % Copper | % Copper |
|---|---|---|
| | Recovery | Recovery |
| | after 15 hrs. | after 72 hrs. |
| Conditions | Leaching | Leaching |
| 6 gm/liter chalcopyrite | 8.4 | 14.5 |
| 10 gm/liter ferric-chloride | | |
| 1.3 pH using H₂SO₄ | | |
| 6 gm/liter chalcopyrite | 100 | 100 |
| 10 gm/liter ferric-chloride | | |
| 20% commercial bleach (75 gm) | | |
| 1.3 pH using H₂SO₄ | | |
| 6 gm/liter chalcopyrite | 50 | 100 |
| 10 gm/liter ferric-chloride | | |
| 75 gm/liter chlorate | | |
| 1.3 pH using H₂SO₄ | | |

These experiments show that a high concentration of oxidants is required to destroy the sulfur layer and thereby enhance the copper dissolution.

### EXAMPLE III

### Effect of Concentration of Nanosilica

The effect of nanosize silica on copper dissolution is given in Table 3. By increasing the nanosize silica concentration from 5 gm/liter to 10 gm/liter, it is seen that the copper dissolution increases from 12% to 62%.

TABLE 3
Effect of Nanosize Silica on Dissolution of Copper
from Chalcopyrite Experimental Conditions: 10 gm/liter
chalcopyrite; 0.5 N H₂SO₄; 10 ml/liter ethylene glycol;
10 ml H₂O₂/liter; 75° C.; 24 hr. leaching

| Amount of Silica, gm/liter | Copper Dissolution % |
|---|---|
| 10 | 62 |
| 5 | 50 |
| 0 | 12 |

### EXAMPLE IV

### Effect of Silica During Leaching

In this investigation selected silica compounds were tested to see if they could be used to increase copper leaching without strong oxidants.

TABLE 4
Effect of Silica Compounds on Dissolution of Copper
from Chalcopyrite (200 mesh size, Temp. 50° C.)

| | % Copper | % Copper |
|---|---|---|
| | Recovery | Recovery |
| | after 15 hrs. | after 72 hrs. |
| Conditions | Leaching | Leaching |
| 6 gm/liter chalcopyrite | 8.4 | 14.5 |
| 10 gm/liter ferric-chloride | | |
| 1.3 pH using H₂SO₄ | | |
| 6 gm/liter chalcopyrite | 39 | 81 |
| 10 gm/liter ferric-chloride | | |
| silicic acid (10 cc) | | |
| 1.2 pH using H₂SO₄ | | |
| 6 gm/liter chalcopyrite | 40 | 73 |
| 10 gm/liter ferric-chloride | | |
| 10 gm SiO₂ (nanosize) | | |
| 1.3 pH using H₂SO₄ | | |
| 6 gm/liter chalcopyrite | 29 | 78 |
| 10 gm/liter ferric-chloride | | |
| 10 gm silica gel | | |
| 1.3 pH using H₂SO₄ | | |
| 6 gm/liter chalcopyrite | 52 | 79 |
| 30% hydrogen peroxide (20 cc) | | |
| 10 gm SiO₂ (nanosize) | | |
| 1.3 pH using H₂SO₄ | | |

In all of the above tests it has been shown that addition of silica compounds during chalcopyrite leaching can enhance the copper dissolution.

### EXAMPLE V

### Effect of Particle Size

The effect of particle size on copper leaching from chalcopyrite is shown in Table 5. It can be seen that by decreasing particle size, an increase in copper dissolution from chalcopyrite is noticed. For example, under similar experimental conditions, copper dissolution increased from 50% to 65% within 24 hours by decreasing particle size from 50 mesh to 400 mesh.

TABLE 5
Effect of Particle Size
Experimental Conditions: 10 gm/liter chalcopyrite (with different
size); 0.5 N H₂SO₄; 10 ml/liter ethylene glycol; 10 cc/liter
H₂O₂ (30%/strength); 75° C.; 24 hr. leaching; 3.5 gm/liter silica

| Particle Size, mesh size | Copper Extraction % |
|---|---|
| 50 | 50 |
| 200 | 61 |
| 400 | 65 |

### EXAMPLE VI

### Effect of Ethylene Glycol, Hydrogen Peroxide and Nanosilica

The effect of H₂O₂ and ethylene glycol on dissolution of copper in the presence of nanosilica was evaluated. H₂O₂ and ethylene glycol are very effective in copper dissolution from chalcopyrite. The combination of hydrogen peroxide, ethylene glycol, and nanosilica is presently preferable.

TABLE 6
Role of Ethylene Glycol, Hydrogen Peroxide and Nanosilica
on the Dissolution of Copper from Chalcopyrite
Experimental Conditions: 10 gm/liter chalcopyrite;
0.5 N H₂SO₄; 45° C.; 24 hr. leaching (50 mesh)

| | H₂O₂, | Ethylene glycol | Copper |
|---|---|---|---|
| Silica/gm/liter | gm/liter | cc/liter | Dissolution, % |
| 0 | 0 | 10 | 12 |
| 3.5 | 3.2 | 0 | 8 |
| 3.5 | 3.2 | 10 | 50 |

### EXAMPLE VII

### Effect of Ultraviolet vs Visible Light

In another series of experiments, the photo-catalyzed nature of silica in enhancing copper dissolution from chalcopyrite was monitored. In this case nanosize silica compounds were added to the chalcopyrite slurry at pH 1.5 in the presence and absence of light. In addition, the effect of ultraviolet light on leaching was determined.

TABLE 7
Effect of Ultraviolet and Visible Light on Chalcopyrite
Leaching (200 mesh size, Temp. 50° C.)

| | % Copper |
|---|---|
| | Recovery |
| | after 72 hrs. |
| Conditions | Leaching |
| 6 gm/liter chalcopyrite | 78 |
| 50 cc H₂O₂ (30% strength) | |
| 10 gm SiO₂ (nanosize) | |
| 1.3 pH using H₂SO₄ | |
| light - visible | |
| 6 gm/liter chalcopyrite | 80 |
| 50 cc H₂O₂ (30% strength) | |
| 10 gm SiO₂ (nanosize) | |
| 1.3 pH using H₂SO₄ | |
| UV - light - 72 hours | |
| 6 gm/liter chalcopyrite | 88 |
| 10 gm/liter ferric-chloride | |
| 10 cc of silicic acid | |
| 1.3 pH using H₂SO₄ | |
| UV light - 72 hours | |

The above tests showed that UV light in the presence of silica catalyzes the dissolution of copper from chalcopyrite.

### EXAMPLE VIII

### The Effect of Ultraviolet Light

In another series of experiments the effect of ultraviolet light on the dissolution of copper in the presence of ferric chloride was investigated. It was observed that ultraviolet light has significant influence on copper dissolution. Nyacol is colloidal nanosize silica dispersed in glycol medium.

TABLE 8
Effect of Ultraviolet Light Exposure on
the Leaching of Copper from Chalcopyrite

| | Light | Copper |
|---|---|---|
| Experimental Conditions | Source | Extraction % |
| 10 gm/liter chalcopyrite (50 mesh); | Visible | 12 |
| 10 gm/liter ferric chloride; 10 ml/liter | | |
| ethylene glycol; 10 ml/liter Nyacol; | | |
| 75° C.; 24 hr. leaching | | |
| 10 gm/liter chalcopyrite (50 mesh); | Ultraviolet | 46 |
| 10 gm/liter ferric chloride; 10 ml/liter | Light | |
| ethylene glycol; 10 ml/liter Nyacol; | | |
| 75° C.; 24 hr. leaching | | |

### EXAMPLE IX

### Effect of Temperature

Temperature has a profound effect on the dissolution of copper from chalcopyrite. As can be seen, by increasing temperature from 25° C. to 75° C., copper extraction increased from 2% to 50%.

TABLE 9
Effect of Temperature
Experimental Conditions: 10 gm/liter chalcopyrite;
0.5 N H₂SO₄; 4 hrs. agitation; 3.5 gm/liter
silica; 10 ml H₂O₂/liter; 10 ml/liter ethylene glycol

| Leaching Temperature | Copper Extraction % |
|---|---|
| 25° C. | 2% |
| 45° C. | 36% |
| 75° C. | 50% |

### EXAMPLE X

### The Effect of Ferric Chloride and TiO₂

The effect of ferric chloride along with nanosize silica and the effect of nanosize TiO₂ on the dissolution of copper are given in Table 10. As can be seen, nanosize silica in conjunction with ferric chloride can enhance copper dissolution. It was observed that nanosize TiO₂ can also increase the dissolution of copper in the presence of hydrogen peroxide.

TABLE 10
Effect of Different Oxidants on the
Leaching of Copper from Chalcopyrite

| Experimental Conditions | Copper Extraction % |
|---|---|
| 10 gm/liter chalcopyrite (50 mesh); 0.5 N | 30 |
| H₂SO₄; 10 gm/liter ferric chloride; | |
| 3.0 gm/liter nanosilica; 10 ml/liter | |
| ethylene glycol; 75° C.; 24 hr. leaching | |
| 10 gm/liter chalcopyrite (50 mesh); | 61 |
| 0.5 N H₂SO₄; 3.2 gm/liter H₂O₂; | |
| 3.5 gm/liter TiO₂; 10 ml/liter ethylene | |
| glycol; 10 ml/liter Nyacol; 45° C.; 24 hr. | |
| leaching | |

Although the description above contains many specificities, these should not be construed as limiting the scope of the invention, but as merely providing examples of some of the preferred embodiments. For example, minerals other than chalcopyrite may be used. Also, lixiviants other than those specifically exemplified may be used. Conditions other than those specifically exemplified may be used, as known in the art without undue experimentation. All references cited herein are hereby incorporated by reference to the extent not inconsistent with the disclosure herewith.

### REFERENCES

1. Antonijevic, M. M., Jankovic, Z. and M. Dimitrijevic, “Investigations of the Kinetics of Chalcopyrite Oxidation by Potassium Dichromate,” Hydrometallurgy, 35, pp. 187-201, 1994.
2. Balaz, P., Kupka, D., Bastl, Z. and M. Achimovicova, “Combined Chemical and Bacterial Leaching of Ultra Fine Ground Chalcopyrite,” Hydrometallurgy, 42, pp. 237-244, 1996.
3. Biegler, T. and D. A. Swift, “The Electrolytic Reduction of Chalcopyrite in Acid Solution,” Journal of Applied Electrochemistry, 6, pp. 229-235, 1976.
4. Biegler, T. and D. A. Swift, Journal of Applied Electrochemistry, 9, pp. 545-554, 1979.
5. Dutrizac, J. E., “The Kinetics of Dissolution of Chalcopyrite in Ferric Ion Media,” Metallurgical Transactions B, V. 9B, pp. 431-439, 1978.
6. Fathi, H., “Chalcopyrite Chemistry and Metallurgy,” McGraw-Hill, 1978.
7. Hackl, R. P., Dreisinger, D. B., Peters, E., and J. A. King, “Passivation of Chalcopyrite During Oxidative Leaching in Sulfate Media,” Hydrometallurgy, 39, pp. 25-48, 1995.
8. Havlik, T. and M. Skrobian, “Acid Leaching of Chalcopyrite in the Presence of Ozone,” Canadian Metallurgical Quarterly, V. 29, N. 2, pp.133-139, 1990.
9. Illangovan, S., Nagaraj, D. R. and K. I. Vasu, “Electrometallurgy of Chalcopyrite: Copper Powder from Slurry Anodes,” Journal of Electrochemical Society of India, 24(4), pp. 195-199, 1975.
10. Kruesi, P. R., “Cymet Copper Reduction Process,” Mineral Congress Journal, 60(9), pp. 22-23, 1974.
11. Mateos, B., Perez, I. P., and F. C. Mora, “The Passivation of Chalcopyrite Subjected to Ferric Sulfate Leaching and Its Reactivation with Metal Sulfides,” Hydrometallurgy, No. 19, pp. 159-167, 1987.
12. Miller, J. D. and H. Q. Portillo, J. Laskowski (Ed.), Proceedings of XIII International Mineral Processing Congress, Poland, pp. 691-742, 1979.
13. Munoz, P. B., Miller, J. D. and M. E. Wadsworth, Metallurgical Transactions B, V. 10B, pp. 149-158, 1979.
14. Reilly, I. G. and D. S. Scott, “Recovery of Elemental Sulfur During the Oxidative Ammoniacal Leaching of Chalcopyrite,” Metallurgical Transactions B, V. 15B, pp. 726-729, 1984.
15. Wyckoff, R. W. G., Bull. Soc. Franc. Min. 93(1), pp.120-122, 1970.

We claim:

1. A method of extracting copper from a copper-containing mineral comprising:
adding a lixiviant and a silica-containing compound or titanium-containing compound to
a copper-containing mineral, forming a composition;
separating the copper extracted from the composition.

2. The method of claim 1, wherein the concentration of the silica-containing compound or titanium-containing compound is at least 5 gm/liter in the composition.

3. The method of claim 1, wherein the lixiviant is one or more selected from the group consisting of: ferric ion, oxidants, hydrogen peroxide, ethylene glycol, chlorate, permanganate, bleach, iodide and bacteria.

4. The method of claim 3, wherein the lixiviant is one or more selected from the group consisting of: ferric ion, hydrogen peroxide and ethylene glycol.

5. The method of claim 1, further comprising applying ultraviolet light to the composition.

6. The method of claim 1, further comprising adjusting the pH of the composition to acidic.

7. The method of claim 1, further comprising adjusting the temperature of the composition to between about 25 and 85° C.

8. The method of claim 1, wherein the mineral further comprises sulfur.

9. The method of claim 8, wherein the mineral is chalcopyrite.

10. The method of claim 1, wherein the silica-containing compound or titanium-containing compound has a particle size of less than about 200 microns.

11. The method of claim 1, wherein the titanium-containing compound is titanium dioxide.

12. The method of claim 1, wherein the silica-containing compound is selected from the group consisting of: SiO₂, silicic acid, fluorosilicic acid, glass sand, borosilicate, dissolved silica, silica gel and colloidal silica.

13. A method of extracting copper from a sulfur-containing copper mineral comprising:
adding a lixiviant and a silica-containing compound or titanium-containing compound to a sulfur-containing copper mineral, forming a composition;
adjusting the pH of the composition to be acidic;
adjusting the temperature of the composition to between about 25 and 85° C.; and
separating the extracted copper from the composition.

14. The method of claim 13, further comprising adding ultraviolet light to the composition.

15. The method of claim 13, wherein the lixiviant is one or more selected from the group consisting of: ferric ion, hydrogen peroxide, chlorate, ethylene glycol, permanganate, bleach, iodide and bacteria.

16. The method of claim 15, wherein the lixiviant is one or more selected from the group consisting of: ferric ion, hydrogen peroxide and ethylene glycol.

17. The method of claim 13, wherein the sulfur-containing copper mineral is chalcopyrite.

18. The method of claim 13, wherein the titanium-containing compound is titanium dioxide.

19. The method of claim 13, wherein the silica-containing compound is selected from the group consisting of: SiO₂, silicic acid, fluorosilicic acid, glass sand, borosilicate, dissolved silica, silica gel and colloidal silica.

20. The method of claim 1, wherein the silica-containing compound or titanium-containing compound has a particle size of less than 200 microns.

21. A method of extracting copper from a sulfur-containing copper mineral comprising:
adding one or more lixiviants selected from the group consisting of: ferric ion, hydrogen peroxide and ethylene glycol, and a silica-containing compound or titanium-containing compound to a sulfur-containing copper mineral, forming a composition, wherein the concentration of sulfur-containing copper mineral:silica-containing compound or titanium-containing compound is about 1:1;
adjusting the pH of the composition to be acidic;
adjusting the temperature of the composition to above about 45° C.;
applying ultraviolet light to the composition; and
separating the extracted copper from the composition.

22. A method of extracting copper from a copper mineral comprising:
adding a silica-containing or titanium-containing compound and one or more substances selected from the group consisting of: ethylene glycol, ferric ion and hydrogen peroxide to a copper-containing mineral, forming a composition;
separating the copper extracted from the composition.

23. The method of claim 22, wherein the copper-containing mineral includes sulfur.

24. The method of claim 22, wherein the copper-containing mineral is chalcopyrite.

25. A method of extracting copper from a copper mineral comprising:
adding ethylene glycol, ferric ion, hydrogen peroxide and a silica-containing compound to a copper-containing mineral, forming a composition;
separating the copper extracted from the composition.

26. The method of claim 25, wherein the copper-containing mineral includes sulfur.

27. The method of claim 25, wherein the copper-containing mineral is chalcopyrite.
